(19) United States
(12) Patent Application Publication
(10) Pub. No.: US 2026/0178701 A1
(43) Pub. Date: Jun. 25, 2026

(54) PIXEL BASED VISUAL ANOMALY DETECTION WITH DISTRIBUTED COMPUTING FOR INDUSTRIAL SOLUTION

(71) Applicant: HITACHI VANTARA LLC, Santa Clara, CA (US)

(72) Inventors: Mohan WANG, Issaquah, CA (US); Mauro Arduino DAMO, Windermere, FL (US); Wei LIN, Plainsboro, NJ (US)

(21) Appl. No.: 19/124,235

(22) PCT Filed: Oct. 27, 2022
(86) PCT No.: PCT/US2022/045284

§ 371 Date: Apr. 24, 2025

(51) Int. Cl. G06F 18/214; G06T 7/11

(52) U.S. Cl. CPC G06F 18/214; G06T 7/11

(57) ABSTRACT

A method for detecting visual anomalies. The method may include obtaining data for visual anomaly detection; preparing the data for processing; performing user defined color augmentation using distributed computing network on the data to differentiate areas of interest from areas not requiring immediate attention and to classify the areas of interest; training machine learning model using distributed computing network on the data for anomaly detection; deploying the trained machine learning model; performing distributed parallel inferencing on the data using the deployed machine learning model in conjunction with the distributed computing network to generate predicted output; performing post-processing on the predicted output to enhance accuracy level and performance level of the deployed machine learning model, wherein the post-processing comprises performing density-based suppression on the predicted output to suppress false positive predictions through data clustering; and outputting and alerting user of the predicted output indicating areas of the data having visual anomalies.

### BACKGROUND

### Field

The present disclosure is generally directed to a method and a system for detecting visual anomalies.

### Related Art

Visual anomalies are visual representations of objects' abnormal conditions and are common issues experienced by multiple industries. These can be the results of an abnormal patterns, abnormal symptoms, or abnormal statuses associated with objects. Visual anomalies can be broadly presented in different industries in different shapes and forms, examples include contaminations, corrosions, and discolorations in manufacturing, transportation, and energy domain, pathological condition and biological condition deteriorations in medical and biological domain, deforestations in environmental protection domain, crop maturity and yield monitoring in agricultural domain, etc. FIG. 1 illustrates example industries and associated visual anomaly scenarios.

These anomalies can be associated with multiple different scenarios which can result in reduced production efficiency, decrease in yield, that lead to significant loss to normal business operation.

Therefore, a fast, scalable and accurate way to detect and identify locations of these visual anomalies early in the business process is vital to prevent unrecoverable loss and to apply preventive procedures to contain the situations.

### SUMMARY

Aspects of the present disclosure involve an innovative method for detecting visual anomalies, the method may include obtaining data for visual anomaly detection; preparing the data for processing; performing user defined color augmentation using distributed computing network on the data to differentiate areas of interest from areas not requiring immediate attention and to classify the areas of interest, wherein color space associated with the color augmentation comprises at least one of HSV (Hue, Saturation, Value), LAB (CIELAB color space), YCbCr (luminance, chrominance blue, chrominance red), or XYZ; training machine learning model using distributed computing network on the data for anomaly detection; deploying the trained machine learning model; performing distributed parallel inferencing on the data using the deployed machine learning model in conjunction with the distributed computing network to generate predicted output; performing post-processing on the predicted output to enhance accuracy level and performance level of the deployed machine learning model, wherein the post-processing comprises performing density-based suppression on the predicted output to suppress false positive predictions through data clustering; and outputting and alerting user of the predicted output indicating areas of the data having visual anomalies, wherein the distributed computing network utilizes a plurality of worker nodes to provide parallel processing of data.

Aspects of the present disclosure involve an innovative non-transitory computer readable medium, storing instructions for detecting visual anomalies, the instructions may include obtaining data for visual anomaly detection; preparing the data for processing; performing user defined color augmentation using distributed computing network on the data to differentiate areas of interest from areas not requiring immediate attention and to classify the areas of interest, wherein color space associated with the color augmentation comprises at least one of HSV (Hue, Saturation, Value), LAB (CIELAB color space), YCbCr (luminance, chrominance blue, chrominance red), or XYZ; training machine learning model using distributed computing network on the data for anomaly detection; deploying the trained machine learning model; performing distributed parallel inferencing on the data using the deployed machine learning model in conjunction with the distributed computing network to generate predicted output; performing post-processing on the predicted output to enhance accuracy level and performance level of the deployed machine learning model, wherein the post-processing comprises performing density-based suppression on the predicted output to suppress false positive predictions through data clustering; and outputting and alerting user of the predicted output indicating areas of the data having visual anomalies, wherein the distributed computing network utilizes a plurality of worker nodes to provide parallel processing of data.

Aspects of the present disclosure involve an innovative server system for detecting visual anomalies, the server system may include obtaining data for visual anomaly detection; preparing the data for processing; performing user defined color augmentation using distributed computing network on the data to differentiate areas of interest from areas not requiring immediate attention and to classify the areas of interest, wherein color space associated with the color augmentation comprises at least one of HSV (Hue, Saturation, Value), LAB (CIELAB color space), YCbCr (luminance, chrominance blue, chrominance red), or XYZ; training machine learning model using distributed computing network on the data for anomaly detection; deploying the trained machine learning model; performing distributed parallel inferencing on the data using the deployed machine learning model in conjunction with the distributed computing network to generate predicted output; performing post-processing on the predicted output to enhance accuracy level and performance level of the deployed machine learning model, wherein the post-processing comprises performing density-based suppression on the predicted output to suppress false positive predictions through data clustering; and outputting and alerting user of the predicted output indicating areas of the data having visual anomalies, wherein the distributed computing network utilizes a plurality of worker nodes to provide parallel processing of data.

Aspects of the present disclosure involve an innovative system for detecting visual anomalies, the system may include means for obtaining data for visual anomaly detection; means for preparing the data for processing; performing user defined color augmentation using distributed computing network on the data to differentiate areas of interest from areas not requiring immediate attention and to classify the areas of interest, wherein color space associated with the color augmentation comprises at least one of HSV (Hue, Saturation, Value), LAB (CIELAB color space), YCbCr (luminance, chrominance blue, chrominance red), or XYZ; means for training machine learning model using distributed computing network on the data for anomaly detection; deploying the trained machine learning model; means for performing distributed parallel inferencing on the data using the deployed machine learning model in conjunction with the distributed computing network to generate predicted output; means for performing post-processing on the predicted output to enhance accuracy level and performance level of the deployed machine learning model, wherein the post-processing comprises performing density-based suppression on the predicted output to suppress false positive predictions through data clustering; and means for outputting and alerting user of the predicted output indicating areas of the data having visual anomalies, wherein the distributed computing network utilizes a plurality of worker nodes to provide parallel processing of data.

### BRIEF DESCRIPTION OF DRAWINGS

A general architecture that implements the various features of the disclosure will now be described with reference to the drawings. The drawings and the associated descriptions are provided to illustrate example implementations of the disclosure and not to limit the scope of the disclosure. Throughout the drawings, reference numbers are reused to indicate correspondence between referenced elements.

FIG. 1 illustrates example industries and associated visual anomaly scenarios.

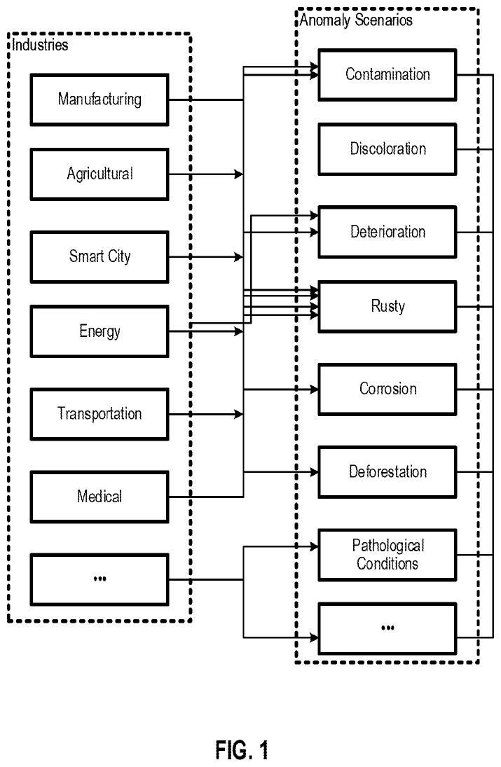

FIG. 2 illustrates an example process flow of the visual anomaly detection process, in accordance with an example implementation.

FIG. 3 illustrates an example annotation process, in accordance with an example implementation.

FIG. 4 illustrates an example data preparation process, in accordance with an example implementation.

FIG. 5 illustrates an example color augmentation process, in accordance with an example implementation.

FIG. 6A illustrates an example model training process with parallelization at the algorithm level, in accordance with an example implementation.

FIG. 6B illustrates an example model training process with parallelization at the data level, in accordance with an example implementation.

FIG. 7 illustrates an example knowledge distillation/business rule extraction process, in accordance with an example implementation.

FIG. 8 illustrates an example distributed parallel inferencing process, in accordance with an example implementation.

FIG. 9A illustrates an example density directed sample inferencing process, in accordance with an example implementation.

FIG. 9B illustrates example density directed sample inferencing processes utilizing both recursive method and non-recursive method, in accordance with an example implementation.

FIG. 10 illustrates example post-processing process involving image segmentation, in accordance with an example implementation.

FIG. 11 illustrates example post-processing process involving shape isolation, in accordance with an example implementation.

FIG. 12 illustrates example post-processing process involving density-based suppression, in accordance with an example implementation.

FIG. 13 illustrates example pixel localization and visualization process, in accordance with an example implementation.

FIG. 14 illustrates example user feedback loop and retraining process, in accordance with an example implementation.

FIG. 15 illustrates an example computing environment with an example computer device suitable for use in some example implementations.

### DETAILED DESCRIPTION

The following detailed description following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Example implementations provide an efficient and scalable way to solve visual anomaly detection challenges faced by different industries. Taking the anomaly definition specified by users, automated anomaly detection is then performed utilizing integrated distributed computing framework to distinguish normal and abnormal cases in association with different backgrounds, shapes, surfaces, and materials.

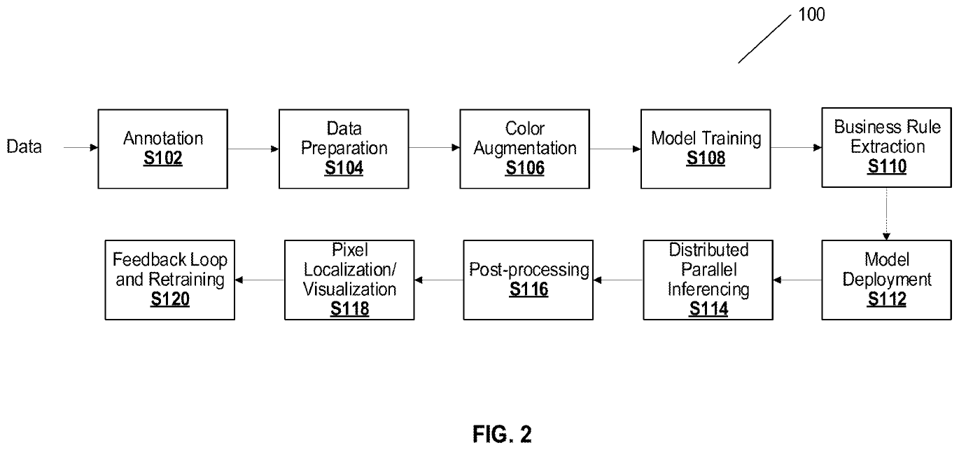

FIG. 2 illustrates an example process flow of the visual anomaly detection process 100, in accordance with an example implementation. The process 100 begins by receiving data and performing annotation on the received data at step S102. The user defines the types of anomalies to be detected and their corresponding color ranges in addition to Red, Green, and Blue values (RGB). All colors in the received data/image(s) include the three basic colors of red, green, and blue. At S104, data preparation is performed to convert the received data/image(s) to tabular format in order to perform machine learning model training. Data preparation comprises three steps of data reshaping, data concatenation, and data reshuffling.

The process then continues to S106, where color augmentation is performed. Color augmentation is utilized to derive other color space values as predictive features to enrich feature space for better prediction accuracy. At S108, machine learning model training is performed. The model training process leverages Automated Machine Learning (AutoML) pipelines to speed up the training process and increase converging speed. In some example implementations, an optional model refining step can be applied to the AutoML results to achieve optimal performance result. In some example implementations, an optional model ensemble can be applied in model training. The various model training methods will be described in more details below.

At S110, knowledge distillation/business rule extraction is performed. Business rule extraction is an optional step that may apply to model generation where rigorous deployment constraints need to be met, e.g. hardware limitation minimal inferencing speed/frequency requirement, etc. At S112, the generated model is deployed.

At S114, distributed parallel inferencing is performed. Distributed parallel inferencing optimizes the inferencing process to make the best use of hardware resources, which enables large data handling and video data processing. At S116, post-processing is performed on the output of S114. In some use cases, identification of edges, contours, or the shapes of the objects is necessary to filter out predicted anomalies on irrelevant objects' surfaces, or to eliminate background noise disturbance which may affect model accuracy. The various post-processing methods will be described in more details below.

At S118, pixel localization/visualization is performed. Pixel localization/visualization is utilized to overcome data transmission constraint when scaling to large datasets or streaming data. Pixel localization can help to minimize data load pressure by only passing necessary information across different clusters. Lastly, user feedback loop and retraining are performed at S120. User feedback loop and retraining store user feedback and restarts the training process when enough sample size collected and to reflect on the latest state.

In addition to the above, distributed computing framework is integrated to various stages of the visual anomaly detection process, such as, but not limited to, data preparation, model training, distributed parallel inferencing, etc. For different stages, there are stage specific methods introduced to achieve parallelized computation at pixel level, frame level, model level, hyperparameter level, etc. Distributed computing enables handling of high-resolution images and large batches of data more efficiently.

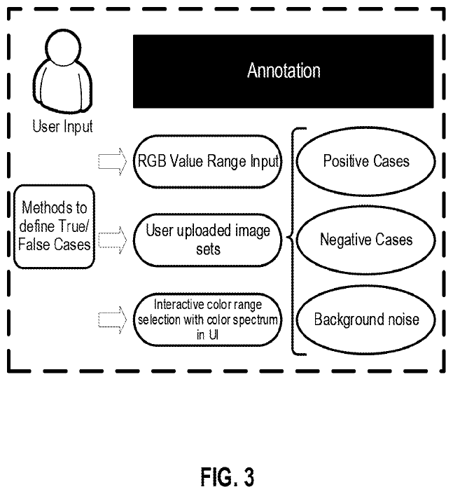

FIG. 3 illustrates an example annotation process, in accordance with an example implementation. In order to train a supervised machine learning model, labeled data with positive and negative examples is required. There are three interactive ways that allow users to define what colors and patterns should be classified as positive anomaly examples, specifically:
1. Specify the desired range, or a sequence of values in RGB code for detection.
2. Identify a batch of pictures/image data to be detected as positive examples.
3. Select RGB code range to be detected by selecting value range in an interactive user session using a user interface (UI).

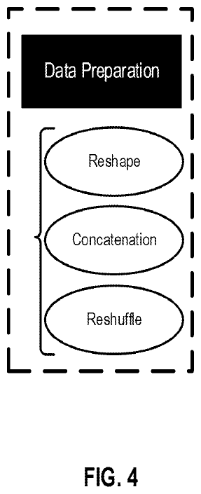

FIG. 4 illustrates an example data preparation process, in accordance with an example implementation. Image data are three dimensional tensors that comprise weight, height, and channel. By itself, image data is not ready for direct application in machine learning model building. To train machine learning model on non-text data, certain data manipulation processes must be performed as part of the preparation. These data manipulation processes include, but not limited to, data reshaping, data concatenation, data reshuffling, etc. Data reshaping involves reshaping loaded image data into a two-dimensional array. Under data concatenation, pixels with same labels are chained/linked together based on dependent variable value assignment. Lastly, data reshuffling involves reshuffling of grouped data to avoid biases.

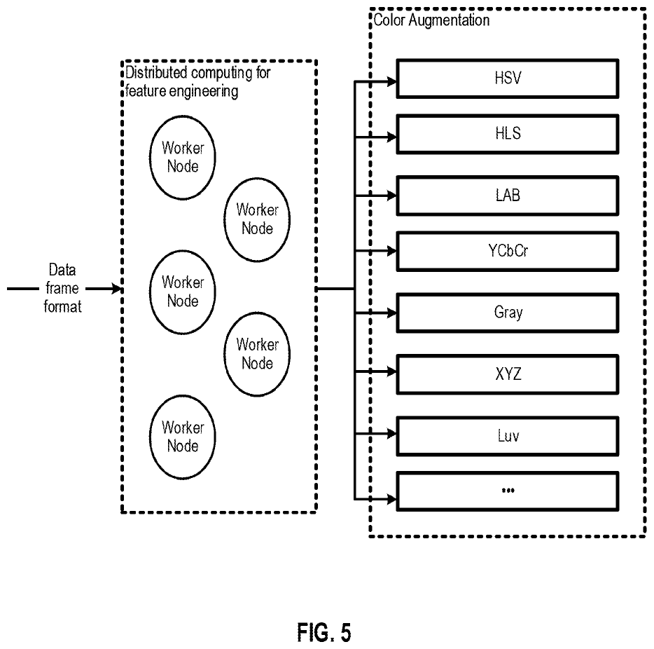

FIG. 5 illustrates an example color augmentation process, in accordance with an example implementation. When common images are labeled using either black/white or RGB colors, only a limited color space is used to represent all the available color spectrum. This restricts the labeling options when assigning anomaly types based solely on black/white or RGB colors. Color augmentation utilizes different color combinations from color spaces other than RGB and black/white to represent various types of visual anomalies to be detected. This helps to better differentiate the visual areas of interest compared to irrelevant background or areas not requiring immediate attention.

Example color spaces for color augmentation include, but not limited to, HSV (Hue, Saturation, and Value), HLS (Hue, Saturation, and Luminance), LAB (CIELAB color space), YCbCr (Luminance, Chrominance Blue, Chrominance Red), Gray, Luv, XYZ, etc. Distributed computing framework is integrated to the color augmentation process to improve processing speed through task allocation to a number of worker nodes.

Following color augmentation, the process continues to the model training process. Automated Machine Learning (AutoML) is the process to automate laborious objective function optimization process by using predefined machine learning pipeline tools to find the optimal solution based on predefined feature space. The AutoML pipeline can be utilized to quickly search for a baseline model for continuous improvement. There are two types of options for AutoML here: 1. open-sourced tools; and 2. self-defined/in-house pipeline. Both options have models such as, but not limited to, Gradient Boosting Model, Generalized Linear Model, Support Vector Machine, Random Forest, Deep Learning Model, etc.

In some example implementation, a machine learning option involves adopting hypermeter settings from open-source tools' best models as starting point for self-defined/in-house automation pipeline. Fine tuning can then be applied parameter value permutation on initial values to avoid model being stuck at local optimal. In some example implementations, an ensemble machine learning model is generated based on a combination of any of the two options above.

Similar to color augmentation, distributed computation framework can also be integrated to the model training process to allow multiple worker nodes training in parallel using different data chunks for asynchronous training, or between different algorithms, or within the same algorithms to improve model converging speed on hyper-parameter space search. This can be achieved through parallelization at the data level or parallelization at the algorithm level.

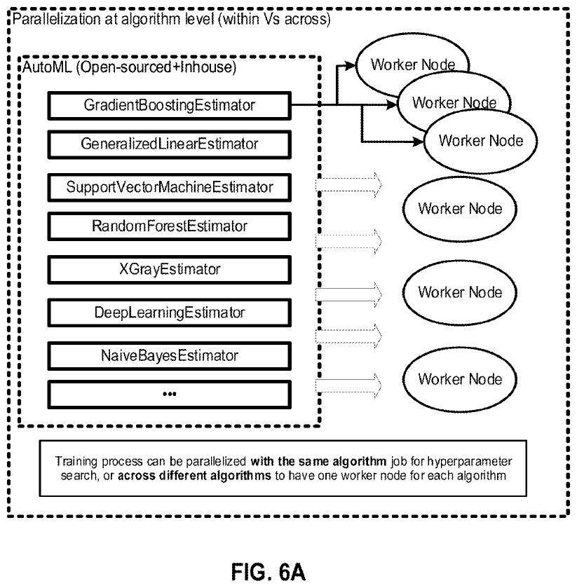

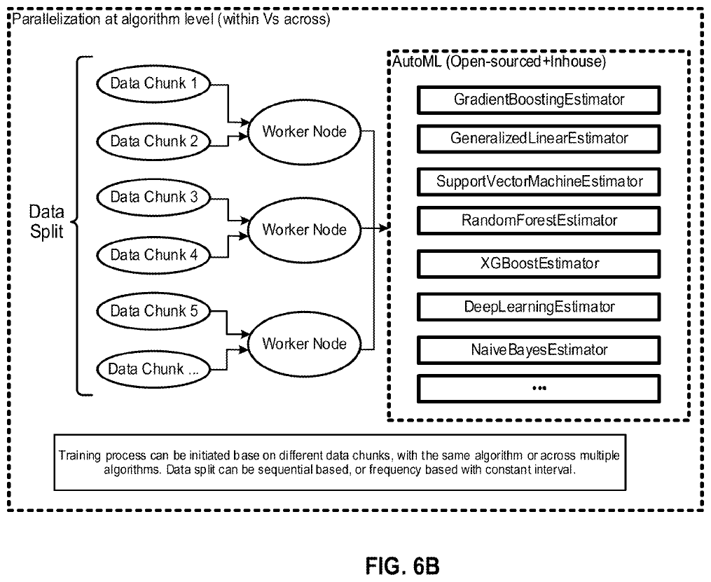

Parallelization at data level: FIG. 6B illustrates an example model training process with parallelization at the data level, in accordance with an example implementation. Under parallelization at the data level, data is split into different chunks, each algorithm will use certain chunks of data for training, and each set of chunks used by each algorithm are independent from each other. Data splitting can be sequential-based or frequency-based with constant interval. Taking data chunks 1-4 of FIG. 6B as example. Data chunks 1-2 are used by a first worker node for model training, whereas data chunks 3-4 are used by a second worker node for model training. The best performing models will be selected based on model performance and continuously trained on unseen data until satisfactory performance is reached. In some example implementations, performance satisfaction is achieved through calculated performance level exceeding or meeting a performance threshold.

Parallelization at algorithm level: FIG. 6A illustrates an example model training process with parallelization at the algorithm level, in accordance with an example implementation. Parallelization can be conducted for the hyperparameter search process within the same algorithm, or have different worker nodes assigned with different algorithms for training.

Model training is a recursive process that gradually drops less predictive features, with the goal of increase model generalization power, decrease model complexity, and alleviate burden for feature preparation whose run time will increase linearly with the increase of image resolution. A feature is a measurable variable that can be used for analysis. The recursive training process comes to a stop when one of three conditions occurs: 1. Performance metrics value drops below a predefined threshold; 2. Predefined minimal number of features to be kept in the final model has been reached; or 3. Predefined ratio cutoff for features to be dropped has been reached.

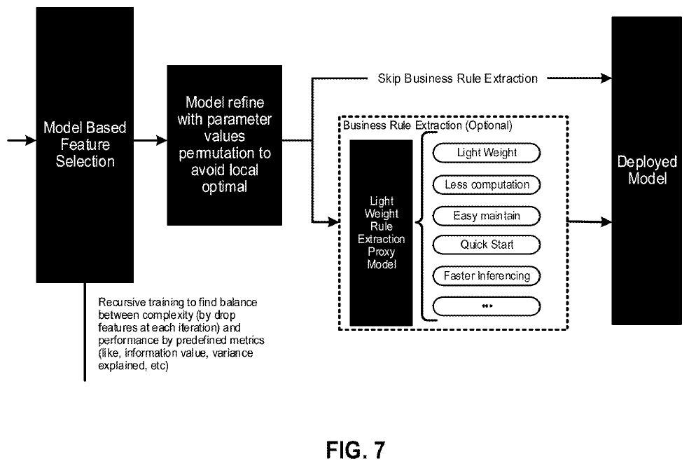

FIG. 7 illustrates an example knowledge distillation/business rule extraction process, in accordance with an example implementation. Depending on deployment requirement, the algorithm having the highest accuracy might not meet the deployment constraint/requirement. Deployment constraints/requirements may include, but not limited to hardware limitation (e.g. CPU, GPU, memory, storage, etc.), minimal inferencing speed/frequency requirement, model size constraint, etc. As illustrated in FIG. 7, such rules may include, but not limited to, light weight, less computation, easy maintenance, quick start, faster inferencing, etc. To address deployment constraint/requirement, business rule extraction process can be utilized to generate a lightweight proxy model. The proxy model can be created using the underlying algorithm or a different algorithm. On completion, the extracted final model will be deployed into the production environment. In some example implementations, the knowledge distillation/business rule extraction process is skipped and the model is deployed directly on completion of parameter refining.

For extraction using model from the same/underlying algorithm family, the proxy model is a simplified version of the initial model that has been retrained using value constraints on parameters that affecting model complexity the most, e.g. tree depth in tree-based model, number of neurons in neuron network model, model quantization (to decrease floating point), regularization factor, etc. Algorithm family refers to models that apply similar methods to decrease model complexity.

For extraction using model from a different algorithm family, the algorithm to be used will be prioritized based on inferencing speed and hardware requirement. After deciding on an algorithm, the model will be retrained and selected based on one having the closest performance level compared to the initial model. Features to be used for model training are the selected features from the same algorithm family at prior step.

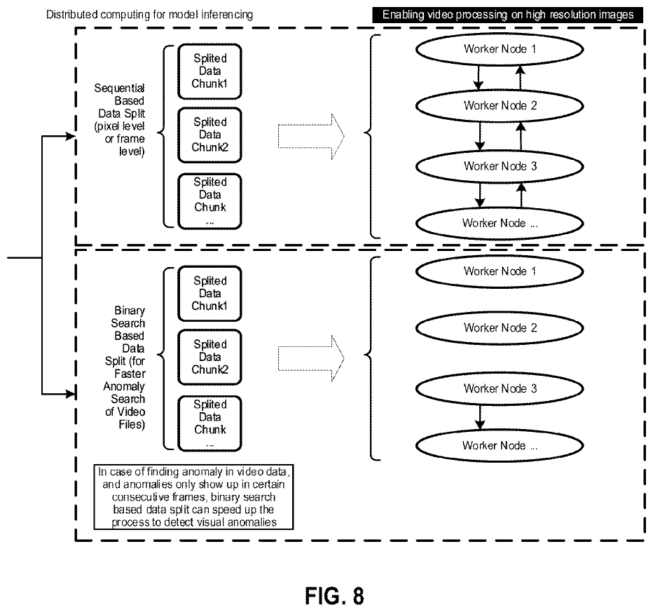

FIG. 8 illustrates an example distributed parallel inferencing process, in accordance with an example implementation. To further enhance inferencing speed, distributed computing framework is integrated to the machine learning inferencing to auto assign worker nodes base on detected hardware configuration. The process provides for distributed parallel generation of machine learning model outputs that utilizes segmented/split data to minimize latency. Methods for splitting data for parallel inferencing include sequential-based data splitting, binary search-based data splitting, and density directed sample inferencing. Each of the three methods will be described in more details below.

1. Sequential Based Data Split: If the input data is a single image, the image is split into multiple chunks, where chunk size equals to the number of worker nodes of the distributed computation framework. If the input data is a batch of images, the images are assigned to the worker nodes, where similar number of images are assigned to each worker node. Latency is reduced through utilization of multiple worker nodes processing in parallel.

2. Binary Search Based Data Split: In the case of visual anomaly detection in video data, anomalies tend to show up in certain consecutive frames. Binary search-based data splitting can be utilized to speed up the visual anomaly detection process by defining a searching window to check if evidence of anomalies exists in the middle (‘middle’ is refer to the medium frame index number) of the searching window. If no anomaly is detected, the searching window size is decreased by half, and searching is initiated for evidence of anomalies in the trimmed searching window. This is a recursive process that continuously trim the searching window size to narrow searching scope for anomaly detection. The searching window trimming process can start from either the left index (starting frame) or the right index (ending frame) of a video. If no anomaly is detected on one side, the process will be applied to the other side which has yet to be searched to complete the search for anomalies. Multiple working nodes can be utilized to speed up the searching process.

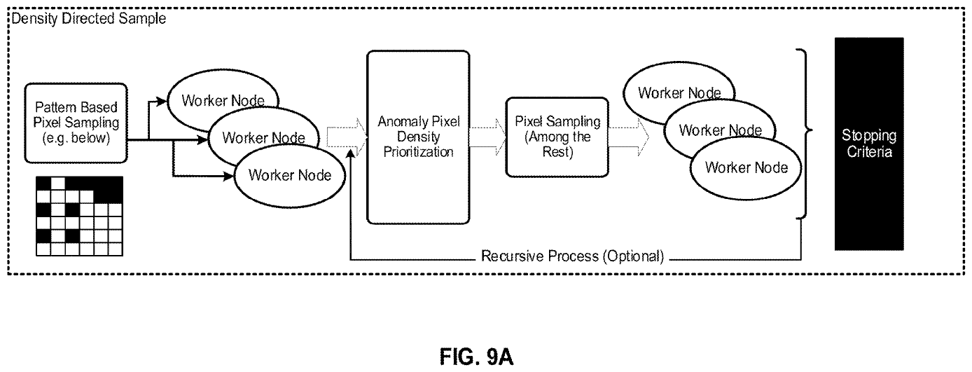

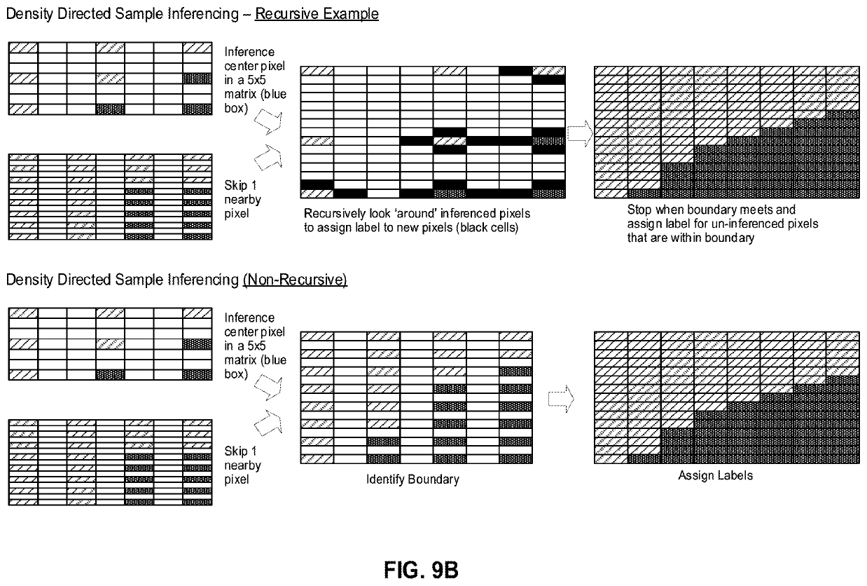

3. Density directed sample inferencing: FIG. 9A illustrates an example density directed sample inferencing process, in accordance with an example implementation. Density directed sample inferencing is a pattern-based pixel sampling that is further divided into recursive method and non-recursive method. For density directed sample inferencing associated using the recursive method, pixels are inferenced by skipping surrounding N pixel points, or picking out the center pixel in every N×N matrix. Since visual anomalies typically appear in clusters, when pixels with anomalies are detected, the recursive process begins density prioritization by searching for detected anomaly pixels' surrounding pixels to identify anomaly boundaries. For example, if pixel [x1, y1] is detected as anomaly pixel, next step in the recursive process will expand the search to the range [x1−n, x1+n], [y1−n, y1+n], and recursively adding more new pixels to that process for inferencing. The process comes to a stop when all anomaly pixels have been detected in N nearby distance.

FIG. 9B illustrates example density directed sample inferencing processes utilizing both recursive method and non-recursive method, in accordance with an example implementation. As illustrated in FIG. 9B, the recursive method begins with the center pixel of every 5×5 matrix inferenced. This is then followed by recursively performing inferencing around the inferenced center pixels, with surrounding adjacent pixels to the inferenced center pixels being inferenced during the first iteration and iteratively expanding by adjacent pixels in every subsequent iteration. The process comes to a stop when the boundary meets and labels are then assigned to pixels yet to be inferenced that are within the boundary.

For density directed sample inferencing using the non-recursive method, pixels are inferenced by skipping surrounding N pixel points, or picking out the center pixel in every N×N matrix. This is then followed by locating estimated boundaries between pixels using positive and negative labels in conjunction with cluster density or Bayesian probability. In some example implementations, inferencing is performed on all pixels between existing boundary to accurately define the boundary. Pixels are assigned labels based on the side of boundary that each pixel belongs. The non-recursive method allows for reduced processing involving inferencing and generates estimated boundary with acceptable level of accuracy.

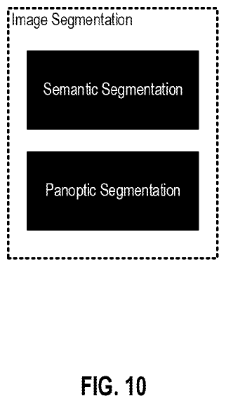

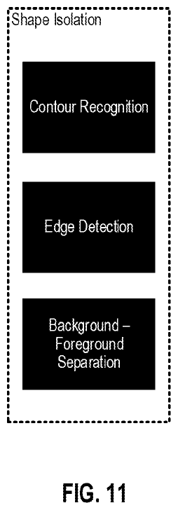

To enhance the accuracy level and performance level achieved in the current visual anomaly detection model, additional post-processing steps can be applied to the inferenced results to reduce background noise or to focus more on specific anomaly types associated with identifiable objects in the input data/image. There are three post-processing approaches applicable to inferenced results:
1. Image Segmentation: FIG. 10 illustrates example post-processing process involving image segmentation, in accordance with an example implementation. Leverage models such as semantics segmentation or panoptic segmentation can be used to differentiate background from foreground of the image data, or filter particular object of interest to detect visual anomalies that exist only on the specific type of object's surface
2. Shape Isolation: FIG. 11 illustrates example post-processing process involving shape isolation, in accordance with an example implementation. Shape isolation can be used to further enhance visual anomaly detection through enhanced shape recognition and object separation. Specifically, three options are available for shape isolation, each targeting a particular business problem for detecting visual anomalies.

Contour recognition: Contour of anomaly area is highlighted and overlaid with predicted visual anomalies. By calculating the detected anomalies/area sizes, severity levels of detected anomalies/area sizes can be estimated.

Edge detection: Edge detection is used to highlight the boundary of anomaly area. By high lighting the boundary of the edge/boundary, visual anomalies such as, but not limited to, crack, leakage, etc. can be easily detected.

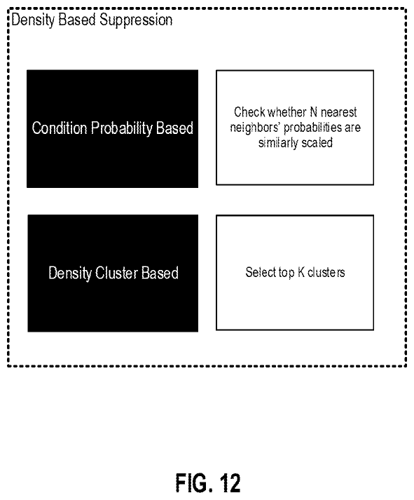

Background/foreground separation: This can be used to highlight visual anomaly on an object in the foreground to further suppress false positive. This helps to isolate objects in the foreground from noisy background.
3. Density-Based Suppression: FIG. 12 illustrates example post-processing process involving density-based suppression, in accordance with an example implementation. Density-based suppression can be used to suppress false positive predictions through data clustering. Two density-based suppression methods can be used to enhance predictions:

Conditional probability-based suppression: Adjust pixels predicted as positive (which exceed probability cutoff) by comparing K nearby pixels' probability to check if they are similarly scaled.

Density-based clustering: Apply unsupervised density-based clustering method to find the K clusters, assign cluster with positive/negative labels by checking probability statistics within the cluster (e.g., mean, median, mod, etc.) Since anomalies appear in clusters, any abnormality detected that is not in a cluster can be filtered using density-based clustering. This can also apply cluster size constraints can also be applied in conjunction with density-based clustering for post-processing.

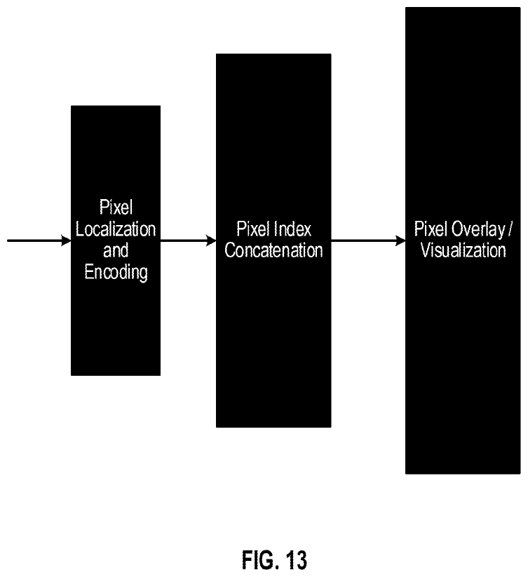

FIG. 13 illustrates example pixel localization and visualization process, in accordance with an example implementation. Pixel localization can be utilized to mitigate traffic load needed to be transferred between different servers for showing inference results on front-end UI in the event of network bottleneck.

The pixel localization process identifies the index location of inferenced pixel having positive results, and concatenate indexes of all detected pixels together. Instead of transferring complete images between different servers. After pixel localization is performed, only the concatenated index list will be transferred to populate and overlay on original image for visualization.

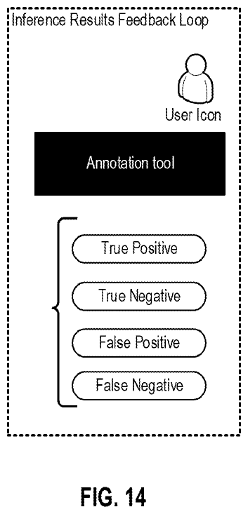

FIG. 14 illustrates example user feedback loop and retraining process, in accordance with an example implementation. Depending on the types of visual anomalies needing to be detected and how situations evolve over time, the user may want to refine color scheme definitions for targeted anomalies or change exiting definitions for targeted anomalies. There are two ways for performing the update:
1. Update color scheme definition by changing the RGB values range. This is achieved by finding a suitable color range and convert the color code to RGB value range. The new color range will be ingested by the data preparation function to assign positive or negative labels correspondingly.
2. Image selection and label assignment. User can preselect a batch of images that contain visual anomalies, and assigning the images with positive labels. The same process will be applied to negative examples based on the images the user provides.

When there are mispredictions such as false positive or false negative, annotation can be used to reject mispredictions, whose labels will be updated based on user input and stored for later retraining/continuous training when there enough samples are collected.

Continuous training/retraining can be performed in two ways. The first approach involves using only corrected false positive and false negative examples. This approach is used when current model is not providing sufficient coverage on visual anomaly color patterns needing to be detected, or when there is a drastic change on visual anomaly color definition. The second approach involves using corrected false positive and false negative examples, and partial previous training examples. This approach is used to fine tune existing model by placing higher priority on edge cases missed out in the current model.

The foregoing example implementation may have various benefits and advantages. For example, a versatile and highly scalable solution is provided that can be applied to challenges faced by different industries for visual anomalies detection during day-to-day operations. In addition, the method can be applied to different domains related for visual anomaly detection with minimal or no change. Utilization of distributed computing network at various stages of anomaly detection makes it easier to scale in increased number of images or image resolutions. Knowledge distillation/business rule extraction process makes deployment less resource intensive and can be deployed to various production environments.

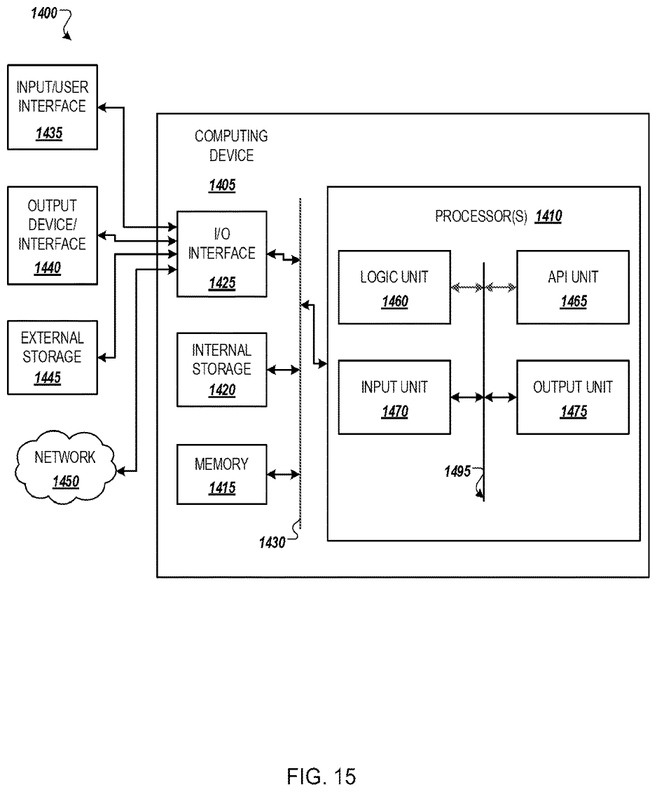

FIG. 15 illustrates an example computing environment with an example computer device suitable for use in some example implementations. Computer device 1405 in computing environment 1400 can include one or more processing units, cores, or processors 1410, memory 1415 (e.g., RAM, ROM, and/or the like), internal storage 1420 (e.g., magnetic, optical, solid-state storage, and/or organic), and/or IO interface 1425, any of which can be coupled on a communication mechanism or bus 1430 for communicating information or embedded in the computer device 1405. IO interface 1425 is also configured to receive images from cameras or provide images to projectors or displays, depending on the desired implementation.

Computer device 1405 can be communicatively coupled to input/user interface 1435 and output device/interface 1440. Either one or both of the input/user interface 1435 and output device/interface 1440 can be a wired or wireless interface and can be detachable. Input/user interface 1435 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 1440 may include a display, television, monitor, printer, speaker, braille, or the like. In some example implementations, input/user interface 1435 and output device/interface 1440 can be embedded with or physically coupled to the computer device 1405. In other example implementations, other computer devices may function as or provide the functions of input/user interface 1435 and output device/interface 1440 for a computer device 1405.

Examples of computer device 1405 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1405 can be communicatively coupled (e.g., via IO interface 1425) to external storage 1445 and network 1450 for communicating with any number of networked components, devices, and systems, including one or more computer devices of the same or different configuration. Computer device 1405 or any connected computer device can be functioning as, providing services of, or referred to as a server, client, thin server, general machine, special-purpose machine, or another label.

IO interface 1425 can include but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 1400. Network 1450 can be any network or combination of networks (e.g., the Internet, local area network, wide area network, a telephonic network, a cellular network, satellite network, and the like).

Computer device 1405 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 1405 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1410 can execute under any operating system (OS) (not shown), in a native or virtual environment. One or more applications can be deployed that include logic unit 1460, application programming interface (API) unit 1465, input unit 1470, output unit 1475, and inter-unit communication mechanism 1495 for the different units to communicate with each other, with the OS, and with other applications (not shown). The described units and elements can be varied in design, function, configuration, or implementation and are not limited to the descriptions provided. Processor(s) 1410 can be in the form of hardware processors such as central processing units (CPUs) or in a combination of hardware and software units.

In some example implementations, when information or an execution instruction is received by API unit 1465, it may be communicated to one or more other units (e.g., logic unit 1460, input unit 1470, output unit 1475). In some instances, logic unit 1460 may be configured to control the information flow among the units and direct the services provided by API unit 1465, the input unit 1470, the output unit 1475, in some example implementations described above. For example, the flow of one or more processes or implementations may be controlled by logic unit 1460 alone or in conjunction with API unit 1465. The input unit 1470 may be configured to obtain input for the calculations described in the example implementations, and the output unit 1475 may be configured to provide an output based on the calculations described in example implementations.

Processor(s) 1410 can be configured to obtain data for visual anomaly detection as shown in FIG. 2. The processor(s) 1410 may also be configured to prepare the data for processing as shown in FIGS. 2 and 4. The processor(s) 1410 may also be configured to perform user defined color augmentation using distributed computing network on the data to differentiate areas of interest from areas not requiring immediate attention and to classify the areas of interest, wherein color space associated with the color augmentation comprises at least one of HSV (Hue, Saturation, Value), LAB (CIELAB color space), YCbCr (luminance, chrominance blue, chrominance red), or XYZ as shown in FIGS. 2 and 5. The processor(s) 1410 may also be configured to train machine learning model using distributed computing network on the data for anomaly detection as shown in FIGS. 2 and 6A-B. The processor(s) 1410 may also be configured to deploy the trained machine learning model as shown in FIG. 2. The processor(s) 1410 may also be configured to perform distributed parallel inferencing on the data using the deployed machine learning model in conjunction with the distributed computing network to generate predicted output as shown in FIGS. 2, 8, and 9A-B. The processor(s) 1410 may also be configured to perform post-processing on the predicted output to enhance accuracy level and performance level of the deployed machine learning model, wherein the post-processing comprises performing density-based suppression on the predicted output to suppress false positive predictions through data clustering as shown in FIG. 2. The processor(s) 1410 may also be configured to output and alert user of the predicted output indicating areas of the data having visual anomalies as shown in FIGS. 2, 8, and 9A-B

The processor(s) 1410 may also be configured to annotate the data with labels, wherein the labels comprise positive example, negative example, and background noise, and wherein positive examples are defined by at least one of range specification, custom sample batch identification, or RGB code range selection as shown in FIGS. 2 and 3.

The processor(s) 1410 may also be configured to perform retraining on the trained machine learning model by using corrected false positive examples and corrected false negative examples associated with the predicted output as shown in FIGS. 2 and 13.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for detecting visual anomalies, the method comprising:
obtaining data for visual anomaly detection;
preparing the data for processing;
performing user defined color augmentation using distributed computing network on the data to differentiate areas of interest from areas not requiring immediate attention and to classify the areas of interest, wherein color space associated with the color augmentation comprises at least one of HSV (Hue, Saturation, Value), LAB (CIELAB color space), YCbCr (luminance, chrominance blue, chrominance red), or XYZ;
training machine learning model using distributed computing network on the data for anomaly detection;
deploying the trained machine learning model;
performing distributed parallel inferencing on the data using the deployed machine learning model in conjunction with the distributed computing network to generate predicted output;
performing post-processing on the predicted output to enhance accuracy level and performance level of the deployed machine learning model, wherein the post-processing comprises performing density-based suppression on the predicted output to suppress false positive predictions through data clustering; and
outputting and alerting user of the predicted output indicating areas of the data having visual anomalies,
wherein the distributed computing network utilizes a plurality of worker nodes to provide parallel processing of data.

2. The method of claim 1, further comprising:
annotating the data with labels,
wherein the labels comprise positive example, negative example, and background noise, and
wherein positive examples are defined by at least one of range specification, custom sample batch identification, or RGB code range selection.

3. The method of claim 2, wherein the preparing the data for processing comprises:
reshaping the data into dimensional index array comprising pixel information;
concatenating entries in the dimensional array by concatenating pixels with same labels together based on dependent variable value assignment; and
reshuffling concatenated entries to avoid bias.

4. The method of claim 3, wherein the training the machine learning model on the data for anomaly detection comprises:
training the machine learning model parallelly using the distributed computation network on historical data and the data.

5. The method of claim 4, the deploying the trained machine learning model comprises:
applying business rule extraction to the trained machine learning model to generate a proxy model that meets deployment constraint; and
deploying the proxy model as the trained machine learning model.

6. The method of claim 5, wherein the performing distributed parallel inferencing on the data comprises:
splitting the data; and
performing parallel inferencing on the split data using the distributed computing network,
wherein the splitting the data comprises performing at least one of sequential-based data split, binary search-based data split, or density directed sample inferencing.

7. The method of claim 6, wherein the post-processing further comprises:
performing image segmentation on the predicted output to enhance visual anomaly detection through enhanced shape recognition and image object separation,
wherein the image segmentation comprises at least one of semantic segmentation or panoptic segmentation.

8. The method of claim 6, wherein the post-processing further comprises:
performing shape isolation on the predicted output to enhance visual anomaly detection through object filtering to differentiate background foreground of the data,
wherein the shape isolation comprises at least one of contour recognition, edge detection, or background/foreground separation.

9. The method of claim 6, wherein the outputting and alerting the predicted output indicating areas of the data having visual anomalies comprises:
performing pixel localization to identify index locations of inferenced pixels having positive results and concatenating the index locations; and
transferring the concatenated index locations for user interface (UI) visualization by performing pixel overlay using the concatenated index locations on the data.

10. The method of claim 6, further comprising:
performing retraining on the trained machine learning model by using corrected false positive examples and corrected false negative examples associated with the predicted output.

11. A non-transitory computer readable medium, storing instructions for detecting visual anomalies, the instructions comprising:
obtaining data for visual anomaly detection;
preparing the data for processing;
performing user defined color augmentation using distributed computing network on the data to differentiate areas of interest from areas not requiring immediate attention and to classify the areas of interest, wherein color space associated with the color augmentation comprises at least one of HSV (Hue, Saturation, Value), LAB (CIELAB color space), YCbCr (luminance, chrominance blue, chrominance red), or XYZ;
training machine learning model using distributed computing network on the data for anomaly detection;
deploying the trained machine learning model;
performing distributed parallel inferencing on the data using the deployed machine learning model in conjunction with the distributed computing network to generate predicted output;
performing post-processing on the predicted output to enhance accuracy level and performance level of the deployed machine learning model, wherein the post-processing comprises performing density-based suppression on the predicted output to suppress false positive predictions through data clustering; and
outputting and alerting user of the predicted output indicating areas of the data having visual anomalies,
wherein the distributed computing network utilizes a plurality of worker nodes to provide parallel processing of data.

12. The non-transitory computer readable medium of claim 11, further comprising:
annotating the data with labels,
wherein the labels comprise positive example, negative example, and background noise, and
wherein positive examples are defined by at least one of range specification, custom sample batch identification, or RGB code range selection.

13. The non-transitory computer readable medium of claim 12, wherein the preparing the data for processing comprises:
reshaping the data into dimensional index array comprising pixel information;
concatenating entries in the dimensional array by concatenating pixels with same labels together based on dependent variable value assignment; and
reshuffling concatenated entries to avoid bias.

14. The non-transitory computer readable medium of claim 13, wherein the training the machine learning model on the data for anomaly detection comprises:
training the machine learning model parallelly using the distributed computation network on historical data and the data.

15. The non-transitory computer readable medium of claim 14, the deploying the trained machine learning model comprises:
applying business rule extraction to the trained machine learning model to generate a proxy model that meets deployment constraint; and
deploying the proxy model as the trained machine learning model.

16. The non-transitory computer readable medium of claim 15, wherein the performing distributed parallel inferencing on the data comprises:
splitting the data; and
performing parallel inferencing on the split data using the distributed computing network,
wherein the splitting the data comprises performing at least one of sequential-based data split, binary search-based data split, or density directed sample inferencing.

17. The non-transitory computer readable medium of claim 16, wherein the post-processing further comprises:
performing image segmentation on the predicted output to enhance visual anomaly detection through enhanced shape recognition and image object separation,
wherein the image segmentation comprises at least one of semantic segmentation or panoptic segmentation.

18. The non-transitory computer readable medium of claim 16, wherein the post-processing further comprises:
performing shape isolation on the predicted output to enhance visual anomaly detection through object filtering to differentiate background foreground of the data,
wherein the shape isolation comprises at least one of contour recognition, edge detection, or background/foreground separation.

19. The non-transitory computer readable medium of claim 16, wherein the outputting and alerting the predicted output indicating areas of the data having visual anomalies comprises:
performing pixel localization to identify index locations of inferenced pixels having positive results and concatenating the index locations; and
transferring the concatenated index locations for user interface (UI) visualization by performing pixel overlay using the concatenated index locations on the data.

20. The non-transitory computer readable medium of claim 16, further comprising:
performing retraining on the trained machine learning model by using corrected false positive examples and corrected false negative examples associated with the predicted output.
